(19) United States
(12) Patent Application Publication
(10) Pub. No.: US 2026/0310994 A1
(43) Pub. Date: Oct. 8, 2026

(54) SYSTEMS AND METHODS FOR AUTONOMOUS GENERATION OF DOMAIN-SPECIFIC ARTIFICIAL INTELLIGENCE MODEL CLUSTERS

(71) Applicant: Abysius Inc., Minnetonka, MN (US)

(72) Inventor: Kevin Friesth, Fort Dodge, IA (US)

(73) Assignee: Abysius Inc., Minnetonka, MN (US)

(21) Appl. No.: 19/637,468

(22) Filed: Apr. 2, 2026

Related U.S. Application Data
(60) Provisional application No. 63/782,251, filed on Apr. 2, 2025.

(51) Int. Cl. G06N 5/022

(52) U.S. Cl. CPC G06N 5/022

(57) ABSTRACT

Systems and methods provide a framework for the automated generation of domain-specific artificial intelligence (AI) model clusters for dynamically processing user prompts. Domain-specific AI models assigned to a particular cluster collaboratively process user prompts to generate a set of responses according to different domains associated with the cluster.

### CROSS-REFERENCE TO RELATED APPLICATIONS

The present patent application claims the priority benefit of U.S. Provisional Patent Application Number 63/782,251 filed April 2, 2025, the disclosures of which are incorporated by reference herein.

### FIELD

The present disclosure relates generally to systems and methods for the automated generation of domain-specific artificial intelligence (AI) model clusters for dynamically processing user prompts. Domain-specific AI models assigned to a particular cluster collaboratively process user prompts to generate a set of responses according to different domains associated with the cluster.

### SUMMARY

Disclosed embodiments provide a framework for the automated generation of domain-specific artificial intelligence (AI) model clusters for dynamically processing user prompts. According to some embodiments, a computer-implemented method is provided. The computer-implemented method comprises processing a set of historical intents to identify intent frequencies. The set of historical intents corresponds to historical user prompts received during historical communications sessions between different users and a generalized autonomous intelligent agent. The computer-implemented method further comprises identifying a set of available domain-specific artificial intelligence (AI) models corresponding to different knowledge domains. The set of available domain-specific AI models is identified according to the intent frequencies. The computer-implemented method further comprises dynamically defining a set of domain-specific AI model clusters based on the set of available domain-specific AI models and the intent frequencies. The set of domain-specific AI model clusters is defined according to one or more intents from the set of historical intents. Furthermore, the one or more intents are selected according to the intent frequencies. The computer-implemented method further comprises generating a knowledge graph according to the set of domain-specific AI model clusters. The knowledge graph associates different domain-specific AI models from the set of available domain-specific AI models with the set of domain-specific AI model clusters according to the one or more intents.

In some embodiments, the computer-implemented method further comprises detecting a new user prompt. The new user prompt is associated with an intent. The computer-implemented method further comprises evaluating the knowledge graph according to the intent to identify a domain-specific AI model cluster from the set of domain-specific AI model clusters. The computer-implemented method further comprises transmitting the new user prompt to a set of domain-specific AI models associated with the identified domain-specific AI model cluster to obtain a set of responses to the new user prompt.

In some embodiments, the computer-implemented method further comprises identifying a set of new domains associated with the one or more intents. The computer-implemented method further comprises dynamically training a new set of domain-specific AI models corresponding to the set of new domains. The computer-implemented method further comprises assigning the new set of domain-specific AI models to the set of domain-specific AI model clusters according to the one or more intents.

In some embodiments, the set of available domain-specific AI models is generated by the generalized autonomous intelligent agent using one or more automated machine learning (AutoML) systems according to the different knowledge domains.

In some embodiments, the computer-implemented method further comprises obtaining feedback corresponding to responses generated by the set of domain-specific AI model clusters to new user prompts. The computer-implemented method further comprises dynamically updating the different domain-specific AI models and the set of domain-specific AI model clusters according to the feedback.

In some embodiments, a set of domain-specific AI models associated with a domain-specific AI model cluster dynamically processes a user prompt corresponding to an assigned intent and intermediate responses generated by the set of domain-specific AI models to generate a collaborative cluster response to the user prompt.

In some embodiments, a set of domain-specific AI model associated with a domain-specific AI model cluster automatically add new domain-specific AI models to the domain-specific AI model cluster based on evaluation of user prompts corresponding to an assigned intent and intermediate responses generated by the set of domain-specific AI models.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which a generalized autonomous intelligent agent dynamically defines different domain-specific AI model committees according to different user intents in accordance with at least one embodiment;

FIG. 2 shows an illustrative example of an environment in which a generalized autonomous intelligent agent dynamically trains and implements a new domain-specific AI model in association with an existing domain-specific AI model committee in accordance with at least one embodiment;

FIG. 3 shows an illustrative example of an environment in which existing domain-specific AI models associated with a domain-specific AI model committee dynamically identify and add a domain-specific AI model to the existing domain-specific AI model committee in accordance with at least one embodiment;

FIG. 4 shows an illustrative example of an environment in which the domain-specific AI models associated with a domain-specific AI model committee collaboratively process a user prompt and intermediate responses to generate a committee response to the user prompt in accordance with at least one embodiment;

FIG. 5 shows an illustrative example of a process for defining different domain-specific AI model committees according to intent frequences and corresponding domains in accordance with at least one embodiment;

FIG. 6 shows an illustrative example of a process for autonomously generating responses to user prompts through domain-specific AI model committees and emotional intelligence processing in accordance with at least one embodiment;

FIG. 7 shows an illustrative example of a process for generating initial responses to a user prompt and transmitting the initial responses to other domain-specific AI models associated within a domain-specific AI model committee to collaboratively generate a committee response to the user prompt in accordance with at least one embodiment; and

FIG. 8 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing preferred examples of embodiments. It is understood that various changes can be made in the function and arrangement of elements without departing from the spirit and scope as set forth in the appended claims.

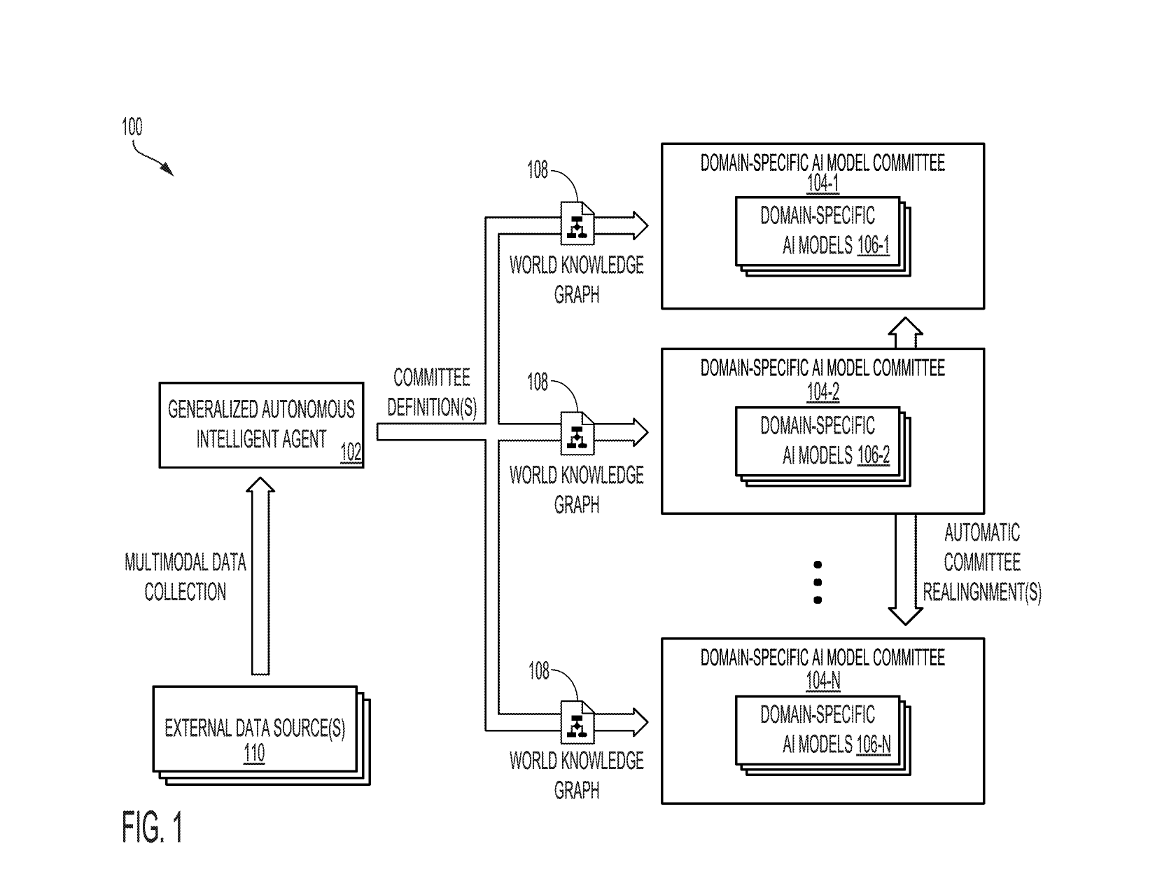

FIG. 1 shows an illustrative example of an environment 100 in which a generalized autonomous intelligent agent 102 dynamically defines different domain-specific AI model committees 104-1 – 104-N according to different user intents in accordance with at least one embodiment. In the environment 100, a generalized autonomous intelligent agent 102 dynamically performs multimodal data collection from one or more external data sources 110 to train different domain-specific AI models and organize these domain-specific AI models into different domain-specific AI model committees 104-1 – 104-N. In an embodiment, the generalized autonomous intelligent agent 102 is dynamically trained to implement and leverage domain-specific AI models to provide sophisticated and refined responses to user prompts and other requests. The generalized autonomous intelligent agent 102 may be dynamically trained using fuzzy logic with a covariance matrix adaptation evolution strategy (CMA-ES) to derive a set of values corresponding to different hyperparameters or other coefficients that, in combination, are used to derive an output given a sample input. For this set of values, a set of weights may be derived through random search, grid search, Bayesian optimization, or other hyperparameter optimization mechanism to fine-tune the hyperparameters of the generalized autonomous intelligent agent 102.

The initial training of the generalized autonomous intelligent agent 102 may be performed using human-in-the-loop (HITL) training techniques. For instance, the generalized autonomous intelligent agent 102 may be dynamically trained using a dataset comprising a large corpus of sample prompts (e.g., historical prompts, hypothetical prompts, combinations of historical and hypothetical prompts, etc.), sample embeddings corresponding to the sample prompts, and sample responses to the sample prompts (e.g., historical responses, hypothetical responses, combinations of historical and hypothetical responses, etc.). The generalized autonomous intelligent agent 104 may process the sample prompts included in the dataset to generate a set of outputs (e.g., responses or other data outputs) corresponding to these sample prompts. Through HITL, an evaluator may compare the set of outputs generated by the generalized autonomous intelligent agent 102 to the sample outputs from the dataset (i.e., expected outputs) to rank the generated outputs and provide corrections to these generated outputs, as necessary.

In an embodiment, the generalized autonomous intelligent agent 102 further implements sets of domain-specific AI models 106-1 – 106-N that are dynamically trained to provide responses to prompts associated with specific knowledge domains. For instance, the generalized autonomous intelligent agent 102 may use one or more automated machine learning (AutoML) systems to generate different domain-specific AI models that may be trained according to assigned domains and that incorporate different sources of knowledge associated with these domains (e.g., reference texts and manuals, domain-specific databases, training datasets, etc.). To generate this set of domain-specific AI models, the one or more AutoML systems may leverage various libraries that correspond to different types of machine learning models. For instance, the one or more AutoML systems may generate the set of domain-specific AI models using recurrent neural networks (RNN), convoluted neural networks (CNN), long short-term memory (LSTM), k-means clustering algorithms, fuzzy c-means (FCM) algorithms, expectation-maximization (EM) algorithms, hierarchical clustering algorithms, density-based spatial clustering of applications with noise (DBSCAN) algorithms, genetic algorithms, backpropagation, reinforcement learning, decision trees, linear classification, anomaly detection, and the like.

In an embodiment, each domain-specific AI model is dynamically trained through knowledge distillation, wherein the generalized autonomous intelligent agent 102 can dynamically obtain different sources of knowledge associated with the particular domain for which the domain-specific AI model is to be implemented and transfers these sources of knowledge to the new domain-specific AI model. In some instances, each domain-specific AI model may be trained through Kolmogorov-Arnold networks (KAN) according to the Kolmogorov-Arnold representation theorem. Additionally, or alternatively, certain domain-specific AI models may be trained to form multilayer perceptrons (MLP). Thus, the domain-specific AI models 106-1 – 106-N may include different domain-specific AI models that are dynamically trained and implemented according to knowledge distillation, KAN, and/or MLP configurations.

In an embodiment, the domain-specific AI models 106-1 – 106-N are organized according to different clusters or committees that correspond to specific domains or other areas of influence. For instance, the generalized autonomous intelligent agent 102 may define a cluster or committee of domain-specific AI models that, collectively, can process prompts or requests corresponding to aircraft design, incorporating domain-specific AI models corresponding to aerodynamic principles, structural analysis, propulsion and thermal analysis, control systems, and the like. As another illustrative example, the generalized autonomous intelligent agent 102 may define a cluster or committee of domain-specific AI models that, collectively, can process prompts or requests corresponding to foreign policy, incorporating domain-specific AI models corresponding to world history, political theory, military doctrines, and the like. To maintain these different clusters or committees 104-1 – 104-N, the generalized autonomous intelligent agent 102 may assign specific keywords or disciplines to the different clusters or committees 104-1 – 104-N in order to maintain a clear division of labor amongst the different domain-specific AI models 106-1 – 106-N implemented by the generalized autonomous intelligent agent 102. Each domain-specific AI model assigned to a particular cluster or committee may be associated with the specific keywords or disciplines such that, when the generalized autonomous intelligent agent 102 selects the particular cluster or committee to review a given prompt and generate a response to the prompt, the prompt may be provided to each of the domain-specific AI models assigned to the cluster or committee.

To train a domain-specific AI model, the generalized autonomous intelligent agent 102 may use fuzzy logic, along with particle swarm optimization (PSO) and CMA-ES with reinforcement learning, for a particular subdiscipline assigned to the model. In some instances, the generalized autonomous intelligent agent 102 may apply a curriculum learning method according to any sources of knowledge associated with the subdiscipline for which the domain-specific AI model is being trained. For instance, using an initial dataset including sample prompts and expected outputs associated with a particular subdiscipline, the generalized autonomous intelligent agent 102 may evaluate the outputs generated by the domain-specific AI model to determine whether these outputs comport with the expected outputs defined in the dataset. If the generated outputs comport with the expected outputs, the generalized autonomous intelligent agent 102 may dynamically adjust the curriculum (i.e., dataset) to incorporate additional subdiscipline resources that may be more complex in nature and involve advanced concepts related to the subdiscipline. The domain-specific AI model may be evaluated against this new dataset to further enhance the capabilities of the domain-specific AI model in processing prompts related to its subdiscipline.

Application of the curriculum learning method, in an embodiment, includes obtaining myriad training materials from different external data sources 110 for training of the domain-specific AI models 106-1 – 106-N. For instance, the generalized autonomous intelligent agent 102 may aggregate data from various external data sources 110, including text-based reference materials, audiovisual recordings, images, news articles, scholarly journals, etc. from diverse domains and sources. Further, the generalized autonomous intelligent agent 102 may utilize web scraping, application programming interfaces (APIs), and any accessible datasets (public and/or private) to obtain additional data that may be used to train the domain-specific AI models 106-1 – 106-N according to their assigned domains. The generalized autonomous intelligent agent 102 may convert the obtained data into corresponding reference embeddings that may be incorporated into the initial datasets used to train the domain-specific AI models 106-1 – 106-N. If the generated outputs comport with the expected outputs, the generalized autonomous intelligent agent 102 may dynamically adjust the curriculum (i.e., dataset) to incorporate additional reference embeddings corresponding to more advanced reference materials from the external data sources 110. The domain-specific AI model may be evaluated against this new dataset, as described above, to further enhance the domain-specific AI model.

In an embodiment, the generalized autonomous intelligent agent 102 maintains a world knowledge graph 108 that provides a representation of the different clusters or committees 104-1 – 104-N of domain-specific AI models that may be leveraged to generate responses to user prompts. This world knowledge graph 108 may be implemented through a data structure that represents the different domain-specific AI models 106-1 – 106-N as individual nodes and any corresponding relationships using edges. The world knowledge graph 108 may further denote the different knowledge domains or other areas of influence associated with each of these individual nodes, which may be used to define the different clusters or committees 104-1 – 104-N of domain-specific AI models implemented by the generalized autonomous intelligent agent 102. The world knowledge graph 108, in an embodiment, is further propagated to the individual domain-specific AI models 106-1 – 106-N to enhance cross-domain knowledge sharing and emergent behavior as new user prompts are processed. In an embodiment, the world knowledge graph 108 is implemented at a central processing unit (CPU) layer of the generalized autonomous intelligent agent system that implements the generalized autonomous intelligent agent 102 and the various domain-specific AI models 106-1 – 106-N. This may allow for efficient identification a cluster or committee of domain-specific AI models that may be leveraged for generation of one or more responses to a user prompt. By maintaining the world knowledge graph 108 at the CPU layer of the generalized autonomous intelligent agent system, other computational resources of the generalized autonomous intelligent agent system (such as graphics processing units (GPUs), tensor processing units (TPUs), neural processing units (NPUs), language processing units (LPUs), etc.) may be reserved for more extensive tasks, including the training of the generalized autonomous intelligent agent 102 and of the domain-specific AI models 106-1 – 106-N, the processing of any user prompts according to an identified domain, the generation of responses to user prompts, and any other computationally intensive operation described herein.

As noted above, a domain-specific AI model committee may include a set of domain-specific AI models that can collectively process user prompts according to their respective knowledge domains to generate responses to these user prompts according to a particular intent or set of intents. For instance, for a given intent, the generalized autonomous intelligent agent 102 may identify the knowledge domains that may be required in order to provide a cogent response to a user prompt associated with the intent. As an illustrative example, an intent corresponding to aircraft design principles may require knowledge domains corresponding to aerodynamics, structural analysis, propulsion and thermal analysis, control systems, and the like. Accordingly, the generalized autonomous intelligent agent 102 may associate domain-specific AI models associated with these identified knowledge domains with a domain-specific AI model committee corresponding to this intent. In some instances, different intents may be associated with one or more common knowledge domains. Accordingly, a domain-specific AI model may be simultaneously associated with two or more domain-specific AI model committees.

In an embodiment, in response to a user prompt, the generalized autonomous intelligent agent 102 may process the user prompt using natural language processing (NLP) techniques to convert the user prompt into a set of prompt embeddings. As noted above, to maintain different clusters or committees 104-1 – 104-N of domain-specific AI models corresponding to different knowledge domains, the generalized autonomous intelligent agent 102 may assign specific keywords or disciplines to the different clusters or committees in order to maintain a clear division of labor amongst the different domain-specific AI models 106-1 – 106-N implemented by the generalized autonomous intelligent agent 102. The generalized autonomous intelligent agent 102, through the world knowledge graph 108, may compare the set of prompt embeddings to these specific keywords or disciplines to identify the appropriate cluster or committee of domain-specific AI models that may be leveraged to generate a response to the user prompt.

In an embodiment, the set of domain specific AI models 106-1 – 106-N and the specialized agents are implemented using computing resources that may be scalable on demand, whereby additional resources may be dynamically implemented in the event of greater resource demand (e.g., data spikes, more stringent bandwidth requirements to limit latency, etc.). In an embodiment, the generalized autonomous intelligent agent 102 dynamically monitors resource utilization of each of the domain specific AI models 106-1 – 106-N to determine whether additional domain specific AI model instances are required for generating responses to different prompts. For instance, if the generalized autonomous intelligent agent 102 determines that a particular domain-specific AI model is failing to satisfy certain performance requirements (e.g., the model is unable to return responses within a threshold period of time, the model is experiencing an input load that exceeds a load threshold, the resources used to implement the model are inoperative or otherwise unavailable for execution of the model, etc.), the generalized autonomous intelligent agent 102 may dynamically provision additional computing resources for instantiation of a new domain-specific AI model that may supplement or replace the particular domain-specific AI model. This new domain-specific AI model may be automatically added to the cluster or committee of domain-specific AI models that the original domain-specific AI model was a member of.

In an embodiment, each cluster or committee of domain-specific AI models 104-1 – 104-N can include additional instances of the different domain-specific AI models that comprise the cluster or committee. These additional instances of the different domain-specific AI models may provide redundancy in the event that a particular domain-specific AI model is unable to process new prompts (e.g., the model is failing particular latency thresholds, the model is inoperative or otherwise unavailable, the model is experiencing a spike in demand, etc.). In an embodiment, upon identifying the appropriate cluster or committee of domain-specific AI models 104-1 – 104-N that may be leveraged to generate a response to the user prompt, the generalized autonomous intelligent agent 102 may dynamically evaluate the performance of each of the domain-specific AI models that comprise the cluster or committee 104-1 – 104-N to identify the particular set of domain-specific AI models to be used for processing the user prompt. This may include selection of particular instances of the different domain-specific AI models according to different performance metrics associated with these instances (e.g., latency, input load, memory utilization, processor utilization, etc.). Based on this evaluation, the generalized autonomous intelligent agent 102 may select the different domain-specific AI model instances within the cluster or committee that may be leveraged for processing of the user prompt.

Once the generalized autonomous intelligent agent 102 has identified the appropriate cluster or committee of domain-specific AI models for processing of the user prompt, the generalized autonomous intelligent agent 102 may transmit the user prompt to each of the domain-specific AI models associated with the cluster or committee to solicit responses to the user prompt. In an embodiment, the domain-specific AI models associated with a particular cluster or committee may individually process an obtained user prompt to generate a response according to the knowledge domain of the domain-specific AI model. For instance, if a user prompt corresponding to a request for an aerodynamic design for a new commercial aircraft is received by a domain-specific AI model trained to provide a performance envelope for different aircraft according to their expected flight profile, the domain-specific AI model may identify the typical flight characteristics of modern commercial aircraft and generate an initial flight envelope for the new commercial aircraft. Using the world knowledge graph 108 associated with the cluster or committee selected for generating a response to the user prompt, the domain-specific AI model may provide this newly generated flight envelope to an aerodynamic design domain-specific AI model, which may use the flight envelope to generate an initial aerodynamic design for a commercial aircraft that can perform within the flight envelope. In turn, the aerodynamic design domain-specific AI model may use the world knowledge graph 108 to identify and provide this aerodynamic design to a structural analysis domain-specific AI model, which may be trained to perform structural analysis (e.g., finite element analysis, etc.) of the aerodynamic design to ensure that the aerodynamic design can withstand the various forces that may be encountered at the various limits of the flight envelope. Thus, the different domain-specific AI models within a cluster or committee may collaboratively process a user prompt according to their individual knowledge domains to generate a cohesive and comprehensive response to the user prompt. Further, each domain-specific AI model may review and refine any outputs generated by the different domain-specific AI models within a cluster or committee to ensure response accuracy. Each domain-specific AI model may also monitor the performance of any downstream domain-specific AI model instances to select the appropriate domain-specific AI model instances to which an output may be provided for further processing.

In an embodiment, the generalized autonomous intelligent agent 102, based on its evaluation of a user prompt and the knowledge domains associated with the selected domain-specific AI model committee, can determine that a new domain-specific AI model is required in order to generate an accurate response to the user prompt. Accordingly, the generalized autonomous intelligent agent 102 may access the external data sources 110 to obtain additional reference materials according to the identified knowledge domain to implement and dynamically train a new domain-specific AI model for the selected domain-specific AI model committee. The new domain-specific AI model may be dynamically trained through knowledge distillation, KAN, and/or MLP according to the configuration of the domain-specific AI model committee and/or the domain assigned to the new domain-specific AI model. The generalized autonomous intelligent agent 102 may dynamically update the world knowledge graph 108 to associate this new domain-specific AI model with the domain-specific AI model committee selected by the generalized autonomous intelligent agent 102 in response to the user prompt.

The execution of the different domain-specific AI models of a particular cluster or committee may be performed in parallel such that each domain-specific AI model may simultaneously process a user prompt according to its corresponding knowledge domain. The outputs from each of these domain-specific AI models may be circulated within the cluster or committee according to the world knowledge graph to further refine these outputs and/or leverage these outputs to converge towards a finalized response to the user prompt. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains.

In an embodiment, the generalized autonomous intelligent agent 102 is implemented using the learning intelligent distribution agent (LIDA) architecture, which is used to process myriad outputs from different domain-specific AI models 106-1 – 106-N associated with different domain-specific AI model committees 104-1 – 104-N to generate a response to a user prompt. The generalized autonomous intelligent agent 102, in an embodiment, implements one or more special-purpose modules that may evaluate any responses generated by the one or more domain-specific AI models associated with the selected cluster or committee to generate a comprehensive response to the user prompt. For instance, if two or more domain-specific AI models produce conflicting responses to a user prompt, the generalized autonomous intelligent agent 102, through the one or more special-purpose modules implemented through the LIDA architecture, may dynamically weigh each response according to the intent expressed by the user in their user prompt and the particular knowledge domains of the domain-specific AI models submitting proposed responses.

In an embodiment, the generalized autonomous intelligent agent 102 may continuously execute continuous reinforcement learning (CRL) using feature map attention loss (FMAL) to further reinforce and/or update the generalized autonomous intelligent agent 102 and domain-specific AI models 106-1 – 106-N. For instance, as users provide feedback with regard to provided responses, the generalized autonomous intelligent agent 102 may determine whether these responses successfully addressed the corresponding user prompts. If a user indicates that a response is unsatisfactory (e.g., the response was incorrect, the response did not comport with the user’s expectations, the response was not responsive to the user prompt, etc.), the generalized autonomous intelligent agent 102 may evaluate this feedback to determine the areas of improvement that should be addressed to improve response accuracy. For example, if the generalized autonomous intelligent agent 102 determines that a particular domain-based AI model has provided an erroneous response according to its domain or area of influence, the generalized autonomous intelligent agent 102 may determine the source of this error and apply the aforementioned curriculum learning method to further train the domain-specific AI model according to its assigned knowledge domain. This process may include identifying additional external data sources 110 from which to obtain additional training materials and enhancing the training dataset used to train the domain-specific AI model by incorporating these additional training materials.

In an embodiment, the generalized autonomous intelligent agent 102 further implements a self-assessment and improvement loop (SAIL) or other feedback loop whereby the generalized autonomous intelligent agent 102 may automatically evaluate its performance, identifies areas for improvement, and autonomously applies updates to improve its performance. For instance, using SAIL, the generalized autonomous intelligent agent 102 may evaluate user feedback to provided responses and accordingly annotate these responses in order to refine its capabilities in processing user prompts and evaluating responses prior to dissemination to users over time. For instance, as feedback is obtained from myriad users over time, the generalized autonomous intelligent agent 102 may identify a need for new domain-specific AI models associated with new knowledge domains, as these new domain-specific AI models may be required to address changing contexts. Accordingly, using SAIL, the generalized autonomous intelligent agent 102 may access the external data sources 110 to obtain additional reference materials (such as those described above) according to the identified knowledge domains to implement and dynamically train these new domain-specific AI models. Thus, as the generalized autonomous intelligent agent 102 and the domain-specific AI models 106-1 – 106-N process different user prompts associated with different users, the generalized autonomous intelligent agent 102 may dynamically retrain and/or reinforce itself and the domain-specific AI models 106-1 – 106-N through the aforementioned methodologies.

In an embodiment, if the generalized autonomous intelligent agent 102 dynamically trains and implements new domain-specific AI models for new knowledge domains, the generalized autonomous intelligent agent 102 can associate these new domain-specific AI models with one or more domain-specific AI model committees 104-1 – 104-N. For example, if a new domain-specific AI model is implemented for a new knowledge domain that may be useful in addressing intents that are associated with domain-specific AI model committee 104-1, the generalized autonomous intelligent agent 102 may dynamically update the world knowledge graph 108 to associate this new domain-specific AI model with the domain-specific AI model committee 104-1. By associating the new domain-specific AI model with the domain-specific AI model committee 104-1, the new domain-specific AI model may collaborate with the domain-specific AI models 106-1 associated with the domain-specific AI model committee 104-1 to generate responses to user prompts corresponding to the assigned intent.

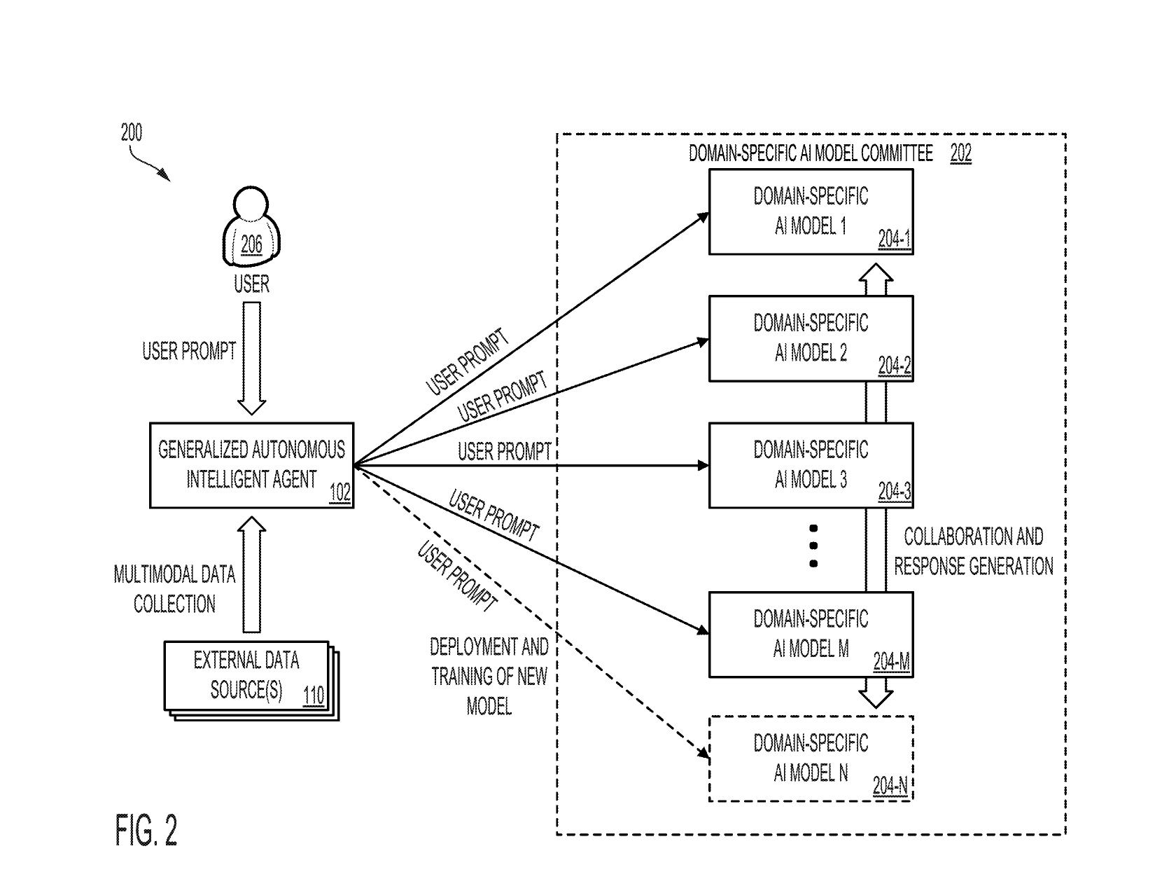

FIG. 2 shows an illustrative example of an environment 200 in which a generalized autonomous intelligent agent 102 dynamically trains and implements a new domain-specific AI model 204-N in association with an existing domain-specific AI model committee 202 in accordance with at least one embodiment. In the environment 200, the generalized autonomous intelligent agent 102 receives, from a user 206, a user prompt corresponding to a request submitted by the user. As noted above, the generalized autonomous intelligent agent 102 is trained to identify, based on evaluation of a received user prompt, the domain-specific AI model committee 202 associated with the knowledge domains required to generate an accurate response to the user prompt. To identify the domain-specific AI model committee 202 for a given user prompt, the generalized autonomous intelligent agent 102 may employ NLP techniques (including NER and dependency parsing) to convert the user prompt into a set of prompt embeddings.

As noted above, the set of domain-specific AI models implemented by the generalized autonomous intelligent agent is organized according to different clusters or committees that correspond to specific knowledge domains or other areas of influence. Returning to an earlier illustrative example, a cluster or committee of domain-specific AI models may be defined that, collectively, can process user prompts or requests corresponding to aircraft design, incorporating domain-specific AI models corresponding to aerodynamic principles, structural analysis, propulsion and thermal analysis, control systems, and the like. As another illustrative example, the generalized autonomous intelligent agent may define a cluster or committee of domain-specific AI models that, collectively, can process prompts or requests corresponding to foreign policy, incorporating domain-specific AI models corresponding to world history, political theory, military doctrines, and the like. To maintain these different clusters or committees, the generalized autonomous intelligent agent may assign specific keywords or disciplines to the different clusters or committees in order to maintain a clear division of labor amongst the different domain-specific AI models implemented by the generalized autonomous intelligent agent. Each domain-specific AI model assigned to a particular cluster or committee may be associated with the specific keywords or disciplines such that, when the generalized autonomous intelligent agent selects the particular cluster or committee to review a given prompt and generate a response to the prompt, the prompt may be provided to each of the domain-specific AI models assigned to the cluster or committee.

In an embodiment, in response to the user prompt, the generalized autonomous intelligent agent 102 compares the set of prompt embeddings corresponding to the user prompt to the embeddings corresponding to the keywords or disciplines associated with the different domain-specific AI model clusters or committees implemented by the generalized autonomous intelligent agent 102. As illustrated in FIG. 2, based on the prompt embeddings corresponding to the user prompt and the particular embeddings associated with the domain-specific AI model committee 202, the generalized autonomous intelligent agent 102 has identified the domain-specific AI model committee 202 as being the cluster or committee associated with the knowledge domains that may be leveraged to provide an accurate response to the user prompt.

Once the generalized autonomous intelligent agent 102 has identified the appropriate domain-specific AI model committee 202 for the user prompt, the generalized autonomous intelligent agent 102 may transmit the user prompt to each of the domain-specific AI models associated with the domain-specific AI model committee 202. For instance, as illustrated in FIG. 2, the domain-specific AI model committee 202 may initially include a set of domain-specific AI models 204-1 - 204-M that are individually trained according to respective knowledge domains and that can collectively provide responses to user prompts associated with one or more particular subjects. Accordingly, the generalized autonomous intelligent agent 102 may transmit the user prompt to each of domain-specific AI models 204-1 – 204-M associated with the selected domain-specific AI model committee 202.

In an embodiment, the generalized autonomous intelligent agent 102, based on its evaluation of a user prompt and the knowledge domains associated with the selected domain-specific AI model committee 202, can determine that a new domain-specific AI model 204-N is required in order to generate an accurate response to the user prompt. As noted above, the generalized autonomous intelligent agent 102 may implement SAIL or other feedback loop mechanisms that allow it to automatically evaluate its performance. Through SAIL or the other feedback loop mechanisms implemented by the generalized autonomous intelligent agent 102, the generalized autonomous intelligent agent 102 may determine that, for the domain-specific AI model committee 202, a new domain-specific AI model 204-N is required in order to provide more accurate responses to user prompts corresponding to the subjects or areas of expertise associated with the domain-specific AI model committee 202. Accordingly, using SAIL or the other feedback loop mechanisms, the generalized autonomous intelligent agent 102 may access the external data sources 110 to obtain additional reference materials according to the identified knowledge domain to implement and dynamically train a new domain-specific AI model 204-N for the domain-specific AI model committee 202. The new domain-specific AI model 204-N may be dynamically trained through knowledge distillation, KAN, and/or MLP according to the configuration of the domain-specific AI model committee 202 and/or the domain assigned to the new domain-specific AI model 204-N.

In an embodiment, the domain-specific AI models 204-1 – 204-N associated with the domain-specific AI model committee 202 individually process the provided user prompt to generate individual responses according to the respective knowledge domain of the domain-specific AI model. Returning to an earlier illustrative example, if a user prompt corresponding to a request for a possible commercial aircraft design is received by a domain-specific AI model trained to define performance envelopes for different aircraft according to their expected flight profiles, the domain-specific AI model may identify the typical flight characteristics of modern commercial aircraft and generate an initial flight envelope for the new commercial aircraft. Using the world knowledge graph associated with the domain-specific AI model committee 202, the domain-specific AI model may provide this newly generated flight envelope to an aerodynamic design domain-specific AI model assigned to the domain-specific AI model committee 202, which may use the flight envelope to generate an initial aerodynamic design for a commercial aircraft that can optimally perform within the flight envelope. In turn, the aerodynamic design domain-specific AI model may provide this aerodynamic design to a structural analysis domain-specific AI model assigned to the domain-specific AI model committee 202, which may be trained to perform structural analysis of the aerodynamic design to ensure that the aerodynamic design can withstand the various forces that may be encountered at the various limits of the flight envelope. Thus, the different domain-specific AI models 204-1 – 204-N within the domain-specific AI model committee 202 may collaboratively process a user prompt according to their individual knowledge domains to generate a cohesive and comprehensive response to the user prompt. Further, each domain-specific AI model 204-1 – 204-N may review and refine any outputs generated by the different domain-specific AI models within the domain-specific AI model committee 202 to ensure response accuracy.

The individual processing of the user prompt by the different domain-specific AI models 204-1 – 204-N is performed in parallel such that the domain-specific AI models 204-1 – 204-N simultaneously process the user prompt and circulate corresponding responses to the domain-specific AI models 204-1 – 204-N associated with the domain-specific AI model committee 202 according to the world knowledge graph to further refine these responses and/or leverage these responses to collaboratively generate a finalized response to the user prompt. Further, the responses generated by the individual domain-specific AI models 204-1 – 204-N may be evaluated according to the knowledge domains of the domain-specific AI models 204-1 – 204-N to identify any inaccuracies or fine-tuning requirements that may be addressed and used to refine these responses. Any updates made to the responses generated by the domain-specific AI models 204-1 – 204-N may be used to refine (e.g., retrain or reinforce) these domain-specific AI models 204-1 – 204-N according to their specific knowledge domains.

As noted above, the generalized autonomous intelligent agent 102 may be implemented using the LIDA architecture, which is used to process myriad outputs from different domain-specific AI models 204-1 – 204-N to generate a response to a user prompt. The generalized autonomous intelligent agent 102 may implement one or more special-purpose modules that may evaluate any responses generated by the one or more domain-specific AI models 204-1 – 204-N associated with the domain-specific AI model committee 202 to generate a comprehensive response to the user prompt. Returning to an earlier illustrative example, if two or more domain-specific AI models produce conflicting responses to a user prompt, the generalized autonomous intelligent agent 102, through the one or more special-purpose modules implemented through the LIDA architecture, may dynamically weigh each response according to the intent expressed by the user in their user prompt and the particular knowledge domains of the domain-specific AI models submitting proposed responses.

In an embodiment, through the LIDA architecture, the generalized autonomous intelligent agent 102 further evaluates the myriad outputs to determine whether any additional domain-specific AI models may be introduced to the domain-specific AI model committee 202 in order to improve the response to the user prompt. For example, if the generalized autonomous intelligent agent 102 determines that the obtained outputs do not include data corresponding to one or more knowledge domains that may be required in order to generate a comprehensive and accurate response to the user prompt, the generalized autonomous intelligent agent 102 may automatically process the world knowledge graph to determine whether other domain-specific AI models trained according to these one or more knowledge domains are available but that are not members of the domain-specific AI model committee. If the generalized autonomous intelligent agent 102 identifies one or more other domain-specific AI models that are available to generate additional outputs according to their knowledge domains, the generalized autonomous intelligent agent 102 may dynamically update the domain-specific AI model committee 202 to introduce these one or more other domain-specific AI models to the domain-specific AI model committee 202. Further, the generalized autonomous intelligent agent 102 may transmit the user prompt to the updated domain-specific AI model committee 202 to solicit new responses to the user prompt. As noted above, the various domain-specific AI models assigned to the domain-specific AI model committee 202 may circulate corresponding individual responses to the domain-specific AI models associated with the domain-specific AI model committee 202 according to the world knowledge graph to further refine these responses and/or leverage these responses to collaboratively generate a finalized response to the user prompt.

Thus, as user prompts are obtained by the generalized autonomous intelligent agent 102, the generalized autonomous intelligent agent 102 may identify domain-specific AI model committees that are associated with the appropriate knowledge domains required to provide comprehensive and accurate responses to these user prompts. Further, the generalized autonomous intelligent agent 102 may dynamically modify any domain-specific AI model committee based on the intent expressed in a user prompt and identification of the knowledge domains required to generate a response to this intent. Additionally, the various domain-specific AI models within a domain-specific AI model committee may further collaborate and evaluate individual responses generated according to specific knowledge domains to internally review, revise, and improve responses that may be provided to the generalized autonomous intelligent agent 102, which may consolidate these responses into a comprehensive response that may be provided to the user in response to the user prompt.

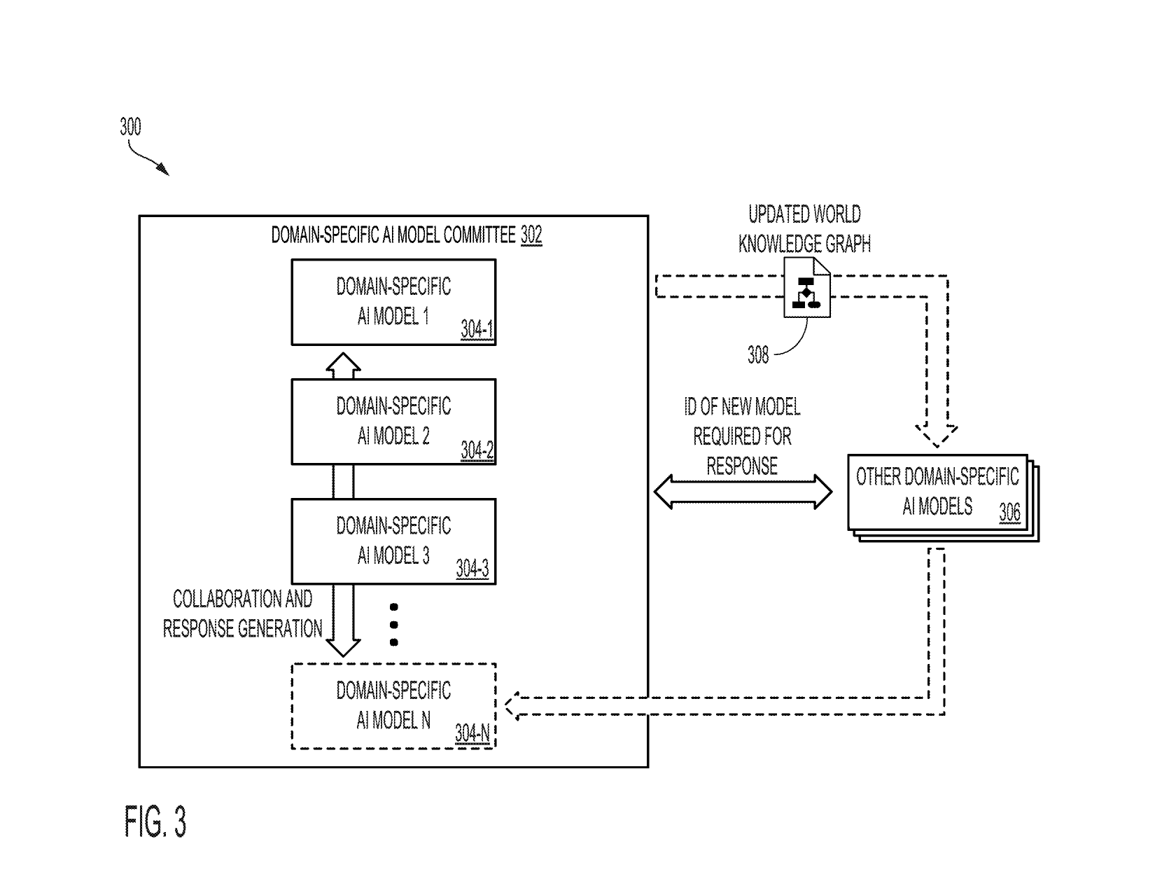

FIG. 3 shows an illustrative example of an environment 300 in which existing domain-specific AI models 304-1 – 304-3 associated with a domain-specific AI model committee 302 dynamically identify and add a domain-specific AI model 304-N to the existing domain-specific AI model committee 302 in accordance with at least one embodiment. In the environment 300, a set of domain-specific AI models 304-1 – 304-3 associated with a domain-specific AI model committee 302 perform individual processing of a user prompt in parallel to simultaneously process the user prompt and circulate corresponding responses to the domain-specific AI models 304-1 – 304-3 associated with the domain-specific AI model committee 302 according to a world knowledge graph. As these domain-specific AI models 304-1 – 304-3 generate individual responses and evaluate other individual responses circulated amongst the domain-specific AI models 304-1 – 304-3, the domain-specific AI models 304-1 – 304-3 may refine these responses and/or leverage these responses to collaboratively generate a finalized response to the user prompt. The responses generated by the individual domain-specific AI models 304-1 – 304-3 may be evaluated according to the knowledge domains of the domain-specific AI models 304-1 – 304-3 to identify any inaccuracies or fine-tuning requirements that may be addressed and used to refine these responses. As noted above, any updates made to the responses generated by the domain-specific AI models 304-1 – 304-3 may be used to refine (e.g., retrain or reinforce) these domain-specific AI models 304-1 – 304-3 according to their specific knowledge domains.

In an embodiment, as the domain-specific AI models 304-1 – 304-3 generate and evaluate individual responses to a received user prompt, one or more of the domain-specific AI models 304-1 – 304-3 may dynamically determine that additional knowledge domains are required in order to provide an accurate response to the received user prompt. For example, one or more domain-specific AI models 304-1 – 304-3, during the processing of the user prompt according to their respective knowledge domains, may determine that a new knowledge domain is required to provide additional functionalities to support the generation of responses to the user prompt. For instance, a domain-specific AI model processing a user prompt may determine that it requires assistance in performing mathematical operations and calculations that are required in order to generate an accurate response according to its knowledge domain. As another illustrative example, a domain-specific AI model processing the user prompt may determine that it requires assistance in performing various language arts functions in order to generate a response that comports with the user’s linguistic idiosyncrasies or other characteristics. As yet another illustrative example, a domain-specific AI model may determine that it requires additional evaluation of programmatic code to ensure that a response that includes the programmatic code can be used without any syntax errors or other issues that may prevent successful execution of the programmatic code.

In an embodiment, if a domain-specific AI model identifies a knowledge domain that is not covered by the existing domain-specific AI models 304-1 – 304-3 of the domain-specific AI model committee 302 but that is otherwise required in order to generate a comprehensive response to a user prompt, the domain-specific AI model may evaluate the world knowledge graph to identify, from the other domain-specific AI models 306 implemented by the generalized autonomous intelligent agent and that are not associated with the domain-specific AI model committee 302, a domain-specific AI model 304-N that may be added to the domain-specific AI model committee 302. As noted above, the generalized autonomous intelligent agent may assign specific keywords or disciplines to the different domain-specific AI model committees in order to maintain a clear division of labor amongst the different domain-specific AI models implemented by the generalized autonomous intelligent agent. Similarly, the generalized autonomous intelligent agent may assign specific keywords to the domain-specific AI models according to their respective knowledge domains. This may allow a domain-specific AI model associated with the domain-specific AI model committee 302, based on the identified knowledge domain that is needed to process the user prompt, to identify the appropriate domain-specific AI model 304-N that may be added to the domain-specific AI model committee 302.

In an embodiment, when a domain-specific AI model adds a new domain-specific AI model 304-N to the domain-specific AI model committee 302, the domain-specific AI model dynamically updates the world knowledge graph 308 to associate the new domain-specific AI model 304-N with the domain-specific AI model committee 302. For instance, the domain-specific AI model may dynamically assign the specific keywords or disciplines associated with the domain-specific AI model committee 302, or an identifier associated with the domain-specific AI model committee 302, to the new domain-specific AI model 304-N.

When the new domain-specific AI model 304-N is added to the domain-specific AI model committee 302, the other domain-specific AI models 304-1 – 304-3 may provide the user prompt, as well as any individual responses generated by the other domain-specific AI models 304-1 – 304-3, to the new domain-specific AI model 304-N. This may allow the new domain-specific AI model 304-N to generate new responses to the user prompt according to its knowledge domain and evaluate and/or refine other responses from the other domain-specific AI models 304-1 – 304-3 according to its knowledge domain to identify any inaccuracies or fine-tuning requirements that may be addressed and used to refine these responses. As noted above, any updates made to the responses generated by the domain-specific AI models may be used to refine (e.g., retrain or reinforce) these domain-specific AI models according to their specific knowledge domains.

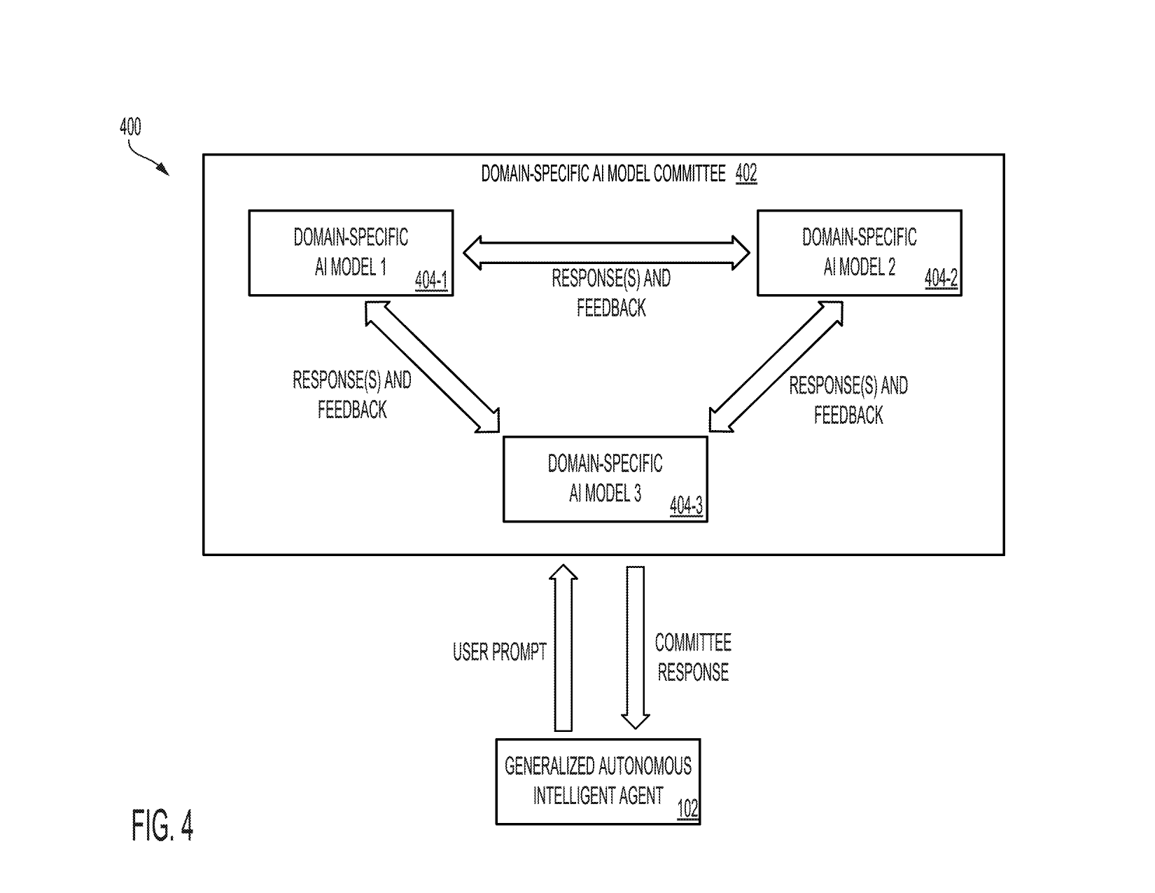

FIG. 4 shows an illustrative example of an environment 400 in which the domain-specific AI models 404-1 – 404-3 associated with a domain-specific AI model committee 402 collaboratively process a user prompt and intermediate responses to generate a committee response to the user prompt in accordance with at least one embodiment. In the environment 400, a generalized autonomous intelligent agent 102 may transmit a user prompt to the different domain-specific AI models 404-1 – 404-3 associated with a domain-specific AI model committee 402. As noted above, the generalized autonomous intelligent agent 102 may select the domain-specific AI model committee 402 for processing the user prompt according to the intent expressed by the user that submitted the user prompt. For example, the generalized autonomous intelligent agent 102 may process the user prompt using NLP techniques to convert the user prompt into a set of prompt embeddings. As noted above, to maintain different clusters or committees of domain-specific AI models corresponding to different knowledge domains, the generalized autonomous intelligent agent 102 may assign specific keywords or disciplines to the different clusters or committees in order to maintain a clear division of labor amongst the different domain-specific AI models implemented by the generalized autonomous intelligent agent 102. The generalized autonomous intelligent agent 102 may compare the set of prompt embeddings to these specific keywords or disciplines to identify the appropriate cluster or committee of domain-specific AI models that may be leveraged to generate a response to the user prompt. Using the aforementioned world knowledge graph associated with different clusters or committees, the generalized autonomous intelligent agent 102, for the domain-specific AI model committee 402 selected for generating a response to the user prompt, may identify the domain-specific AI models 404-1 - 404-3 to which the generalized autonomous intelligent agent 102 may provide the user prompt to obtain responses usable to address the user’s expressed intent.

As noted above, the domain-specific AI models 404-1 – 404-3 associated with the domain-specific AI model committee 402 may individually process the provided user prompt to generate individual responses according to their respective knowledge domains. As these domain-specific AI models 404-1 – 404-3 generate, simultaneously and in parallel, different responses to the user prompt according to their respective knowledge domains, these domain-specific AI models 404-1 – 404-3 may circulate their respective responses within the domain-specific AI model committee 402 according to the world knowledge graph. These different responses may be dynamically evaluated by the other domain-specific AI models of the domain-specific AI model committee 402 to identify any inaccuracies or other fine-tuning requirements that may be addressed in order to refine these responses. Any updates made to the outputs generated by the domain-specific AI models may be used to refine (e.g., retrain or reinforce) these domain-specific AI models according to their specific knowledge domains. Furthermore, if a response generated by a domain-specific AI model associated with the domain-specific AI model committee 402 is required as input to another domain-specific AI model associated with the domain-specific AI model committee 402 in order to generate its own response to the user prompt, the domain-specific AI model, using the world knowledge graph, may transmit its response to the user prompt to this other domain-specific AI model to allow this other domain-specific AI model to use the response to generate its own response.

In an embodiment, as the different domain-specific AI models 404-1 – 404-3 generate, evaluate, and revise different responses to the user prompt, the different domain-specific AI models 404-1 – 404-3 may collectively converge upon a cohesive and comprehensive response to the user prompt. Upon converging upon this cohesive and comprehensive response, the domain-specific AI model committee 402 may provide this response to the generalized autonomous intelligent agent 102, which may evaluate this response to determine whether it may be provided to the user in response to the user prompt. For instance, the generalized autonomous intelligent agent 102 may perform emotion-informed risk assessment of the response to consider emotional aspects when evaluating risks and potential outcomes from providing the response to the user. Based on this evaluation, the generalized autonomous intelligent agent 102 may modify the response to remove any information or other data that may be problematic, thereby addressing any ethical dilemmas detected by the autonomous ethical oversight module.

In some instances, through the LIDA architecture, the generalized autonomous intelligent agent 102 further evaluates the response from the domain-specific AI model committee 402 to determine whether any additional domain-specific AI models may be introduced to the domain-specific AI model committee 402 in order to improve the response to the user prompt. If the generalized autonomous intelligent agent 102 identifies one or more other domain-specific AI models that are available to generate additional outputs according to their knowledge domains, the generalized autonomous intelligent agent 102 may dynamically update the domain-specific AI model committee 402 as described above to introduce these one or more other domain-specific AI models to the domain-specific AI model committee 402. Further, the generalized autonomous intelligent agent 102 may transmit the user prompt to the updated domain-specific AI model committee 402 to solicit new responses to the user prompt. As noted above, the various domain-specific AI models assigned to the domain-specific AI model committee 402 may circulate corresponding individual responses to the domain-specific AI models associated with the domain-specific AI model committee 402 according to the world knowledge graph to further refine these responses and/or leverage these responses to collaboratively generate a finalized response to the user prompt.

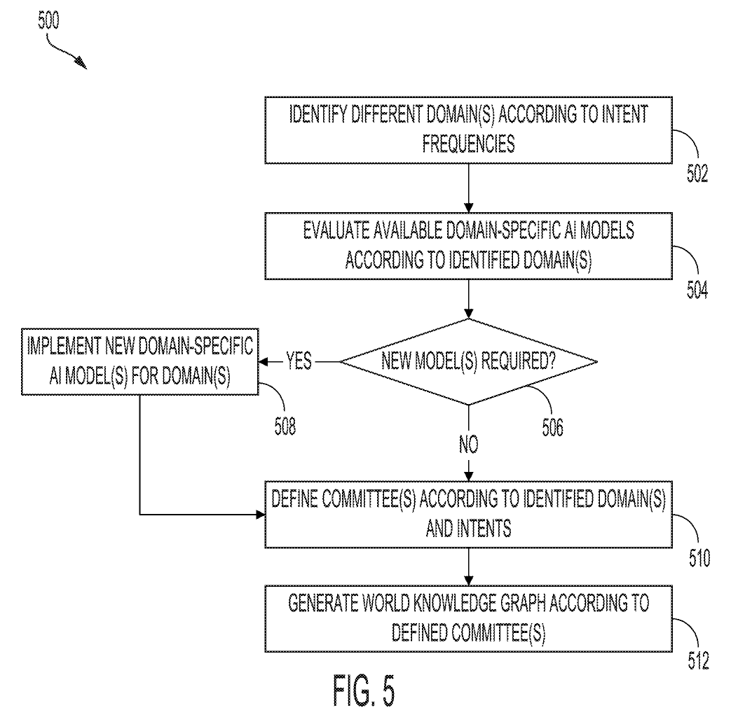

FIG. 5 shows an illustrative example of a process 500 for defining different domain-specific AI model committees according to intent frequences and corresponding domains in accordance with at least one embodiment. The process 500 may be performed by a generalized autonomous intelligent agent.

At step 502, the generalized autonomous intelligent agent may identify one or more different domains according to different intent frequencies. In an embodiment, the generalized autonomous intelligent agent maintains a historical user datastore that is implemented to dynamically and automatically record communications exchanged between different users and the generalized autonomous intelligent agent. For instance, for a given user, the historical user datastore may include an entry corresponding to the user and within which the generalized autonomous intelligent agent may store the communications exchanged between the user and the generalized autonomous intelligent agent over time. As the user and the generalized autonomous intelligent agent begin to exchange communications through an ongoing communications session, the generalized autonomous intelligent agent may automatically record these exchanged communications within this entry associated with the user. Furthermore, the generalized autonomous intelligent agent may record any feedback provided by the user with regard to any communications (e.g., tailored responses) provided by the generalized autonomous intelligent agent within this entry.

In an embodiment, through this historical user datastore, the generalized autonomous intelligent agent specifies the different intents associated with different user prompts previously processed by the generalized autonomous intelligent agent. For instance, the generalized autonomous intelligent agent may employ NLP techniques (including NER and dependency parsing) to convert received user prompts into sets of prompt embeddings that may be used to identify the expressed user intents. An intent may (for example) be a topic, sentiment, complexity, and/or level of urgency. A topic can include, but is not limited to, a subject, a product, a service, a technical issue, a use question, a complaint, etc. In an embodiment, the generalized autonomous intelligent agent may maintain a set of intent embeddings corresponding to known intents previously encountered by the generalized autonomous intelligent agent and/or that the generalized autonomous intelligent agent is trained to identify from submitted user prompts. Thus, to detect an expressed user intent, the generalized autonomous intelligent agent may compare the set of prompt embeddings corresponding to the user prompt to the set of intent embeddings to identify matching intent embeddings. From these matching intent embeddings, the generalized autonomous intelligent agent may determine the user’s expressed intent. Through evaluation of historical user prompts using NLP techniques, the generalized autonomous intelligent agent may identify corresponding intents historically encountered by the generalized autonomous intelligent agent. Further, through this evaluation and identification of intents expressed by different users, the generalized autonomous intelligent agent may identify, for each intent, the frequency of each intent over time.

In an embodiment, the generalized autonomous intelligent agent can define a threshold intent frequency that can be used to identify intents that are more commonly processed by the generalized autonomous intelligent agent. The threshold intent frequency may correspond to a minimum number of user prompts received over a pre-defined period of time that are associated with a given intent. Thus, an intent that is encountered a number of times greater than this threshold intent frequency over this pre-defined period of time may be designated as being a popular intent that may require specialized processing, such as through domain-specific AI model committees.

In an embodiment, for a given intent, the generalized autonomous intelligent agent can identify different knowledge domains that may be required to address requests associated with the intent. As noted above, for a given intent, the generalized autonomous intelligent agent may identify the knowledge domains that may be required in order to provide a cogent response to a user prompt associated with the intent. Returning to an earlier illustrative example, an intent corresponding to aircraft design principles may require knowledge domains corresponding to aerodynamics, structural analysis, propulsion and thermal analysis, control systems, and the like. Accordingly, the generalized autonomous intelligent agent may associate domain-specific AI models associated with these identified knowledge domains with a domain-specific AI model committee corresponding to this intent. In some instances, different intents may be associated with one or more common knowledge domains. Accordingly, a domain-specific AI model may be simultaneously associated with two or more domain-specific AI model committees.

At step 504, the generalized autonomous intelligent agent may evaluate the pool of available domain-specific AI models according to these identified knowledge domains to determine, at step 506, whether new domain-specific AI models corresponding to one or more of these identified knowledge domains are required. For instance, if the generalized autonomous intelligent agent determines that, for a given knowledge domain, the generalized autonomous intelligent agent does not maintain a corresponding domain-specific AI model, the generalized autonomous intelligent agent, at step 508, may implement a new domain-specific AI model corresponding to this knowledge domain. The generalized autonomous intelligent agent may use one or more AutoML systems to generate different domain-specific AI models that may be trained according to assigned domains and that incorporate different sources of knowledge associated with these domains. The one or more AutoML systems may leverage various libraries that correspond to different types of machine learning models, as described above. Each domain-specific AI model may be dynamically trained through knowledge distillation, KAN, and/or MLP configurations.

At step 510, the generalized autonomous intelligent agent defines a set of domain-specific AI model committees or clusters according to the knowledge domains associated with the intents identified as having surpassed the intent frequency threshold. As noted above, the domain-specific AI models associated with the identified intents may be organized according to different clusters or committees that correspond to specific domains or other areas of influence. For instance, the generalized autonomous intelligent agent may define a cluster or committee of domain-specific AI models that, collectively, can process prompts or requests corresponding to aircraft design, incorporating domain-specific AI models corresponding to aerodynamic principles, structural analysis, propulsion and thermal analysis, control systems, and the like. As another illustrative example, the generalized autonomous intelligent agent may define a cluster or committee of domain-specific AI models that, collectively, can process prompts or requests corresponding to foreign policy, incorporating domain-specific AI models corresponding to world history, political theory, military doctrines, and the like. To maintain these different clusters or committees, the generalized autonomous intelligent agent may assign specific keywords or disciplines to the different clusters or committees in order to maintain a clear division of labor amongst the different domain-specific AI models implemented by the generalized autonomous intelligent agent. Each domain-specific AI model assigned to a particular cluster or committee may be associated with the specific keywords or disciplines such that, when the generalized autonomous intelligent agent selects the particular cluster or committee to review a given prompt and generate a response to the prompt, the prompt may be provided to each of the domain-specific AI models assigned to the cluster or committee.

At step 512, the generalized autonomous intelligent agent may generate a world knowledge graph according to these defined domain-specific AI model committees or clusters. This world knowledge graph may be implemented through a data structure that represents the different domain-specific AI models as individual nodes and any corresponding relationships using edges. The world knowledge graph may further denote the different knowledge domains or other areas of influence associated with each of these individual nodes, which may be used to define the different clusters or committees of domain-specific AI models implemented by the generalized autonomous intelligent agent. The world knowledge graph, in an embodiment, is further propagated to the individual domain-specific AI models to enhance cross-domain knowledge sharing and emergent behavior as new user prompts are processed.

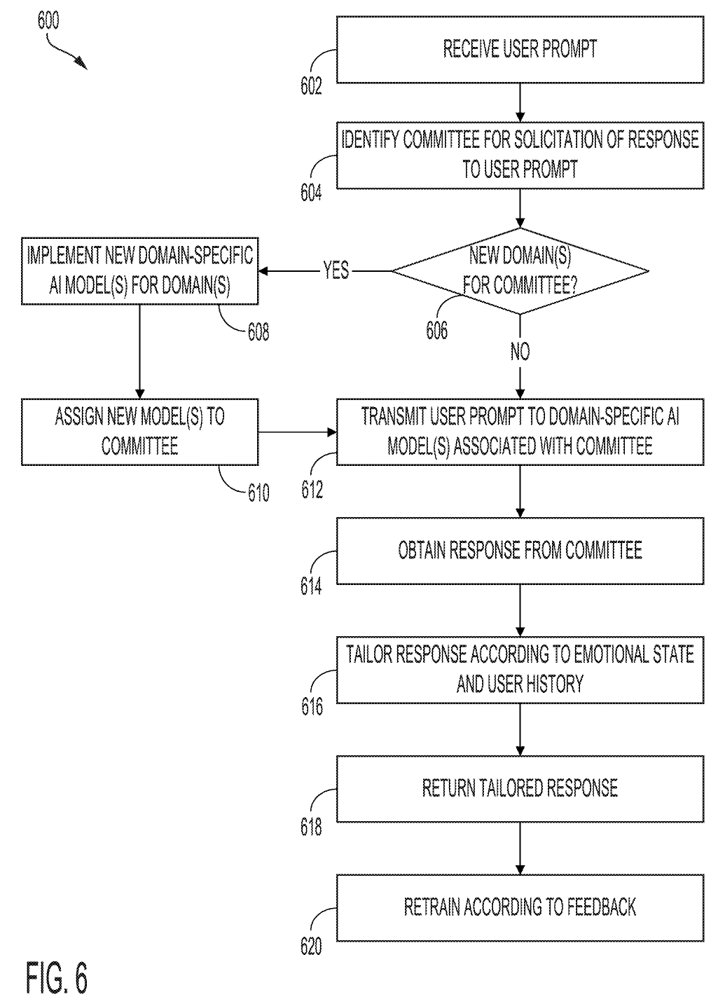

FIG. 6 shows an illustrative example of a process 600 for autonomously generating responses to user prompts through domain-specific AI model committees and emotional intelligence processing in accordance with at least one embodiment. The process 600 may be performed by a generalized autonomous intelligent agent that implements various domain-specific AI models and corresponding domain-specific AI model committees for addressing user intents.

At step 602, the generalized autonomous intelligent agent may receive a user prompt from a user. As noted above, the generalized autonomous intelligent agent may be integrated with an agent interface through which users may engage with the generalized autonomous intelligent and submit user prompts or other requests. This agent interface may be implemented through a web portal and/or native application executing on a user computing device. In some instances, the user prompt may be received through other devices, such as Internet-of-Things (IoT) devices, which may integrate the generalized autonomous intelligent agent. This may allow a user to submit their user prompt through control inputs (such as through a controller, remote-control device, etc.) or voice commands.

At step 604, the generalized autonomous intelligent agent, in response to the user prompt, may identify a domain-specific AI model committee for solicitation of a response to the user prompt. For instance, in response to the user prompt, the generalized autonomous intelligent agent may evaluate the user prompt to detect an expressed user intent. Based on this intent, the generalized autonomous intelligent agent may identify one or more domains associated with the identified intent. As noted above, the generalized autonomous intelligent agent may maintain a world knowledge graph representation of the different clusters or committees of domain-specific AI models that may be leveraged to generate responses to user prompts. This world knowledge graph may be implemented through a data structure that represents the different domain-specific AI models maintained by the generalized autonomous intelligent agent as individual nodes and any corresponding relationships among these models using edges. The world knowledge graph may further denote the different domains or other areas of influence associated with each of these individual nodes, which may be used to define the different clusters or committees of domain-specific AI models implemented by the generalized autonomous intelligent agent. Using this world knowledge graph and the identified intent, the generalized autonomous intelligent agent may dynamically identify a particular domain-specific AI model committee that may solicited to obtain a response to the user prompt.

At step 606, the generalized autonomous intelligent agent may determine whether there are any additional knowledge domains that may be added to the selected domain-specific AI model committee in order to provide a more accurate response to the user prompt. As noted above, the generalized autonomous intelligent agent may implement SAIL or other feedback loop through which the generalized autonomous intelligent agent may automatically evaluate its historical performance, identify areas for improvement, and autonomously apply updates to improve its performance. Returning to an earlier illustrative example, as feedback is obtained from myriad users over time, the generalized autonomous intelligent agent may identify a need for new domain-specific AI models associated with new knowledge domains, as these new domain-specific AI models may be required to address changing contexts. Similarly, the generalized autonomous intelligent agent may evaluate the user prompt to determine the context of the user’s request and of the identified intent to determine whether there is a need for new domain-specific AI models to address this intent according to the context of the request. In some instances, this determination may be made as a result of a threshold number of similar user prompts being received over a period of time, which may denote a need for new domain-specific AI models that may be implemented to address these user prompts.

If the generalized autonomous intelligent agent determines that addressing the user prompt required new domains, the generalized autonomous intelligent agent, at step 608, may implement one or more new domain-specific AI models for these new domains. As noted above, using SAIL, the generalized autonomous intelligent agent may access one or more external data sources to obtain additional reference materials (such as those described above) according to the identified knowledge domains to implement and dynamically train these new domain-specific AI models. Further, as these new domain-specific AI models are dynamically trained and implemented according to their respective knowledge domains, the generalized autonomous intelligent agent may dynamically update the world knowledge graph to incorporate these new domain-specific AI models and to define any relationships among these new domain-specific AI models and existing domain-specific AI models. At step 610, the generalized autonomous intelligent agent may assign these newly generated domain-specific AI models to the existing domain-specific AI model committee by associating these new domain-specific AI models with the existing domain-specific AI model committee in the world knowledge graph. The one or more new domain-specific AI models for the identified knowledge domains may be dynamically trained through knowledge distillation, KAN, and/or MLP according to the configuration of the domain-specific AI model committee and/or the domain assigned to the new domain-specific AI models.

At step 612, the generalized autonomous intelligent agent may transmit the user prompt to the domain-specific AI models corresponding to the identified domain-specific AI model committee. The domain-specific AI models associated with the selected domain-specific AI model committee may individually process an obtained user prompt to generate a response according to the knowledge domain of the domain-specific AI model. The individual domain-specific AI models may further evaluate the world knowledge graph to provide any outputs to other domain-specific AI models within the cluster or committee that may require these outputs in order to generate additional outputs responsive to the user prompt. This process allows the different domain-specific AI models within a cluster or committee to collaboratively process a user prompt according to their individual knowledge domains to generate a cohesive and comprehensive response to the user prompt. Further, each domain-specific AI model may review and refine any outputs generated by the different domain-specific AI models within a cluster or committee to ensure response accuracy.

At step 614, the generalized autonomous intelligent agent obtains one or more responses from the domain-specific AI models associated with the selected domain-specific AI model committee. At step 616, the generalized autonomous intelligent agent may select a response to the user prompt and tailor this response according to the emotional state of the user and the user’s own personal history. As noted above, the generalized autonomous intelligent agent is implemented using the LIDA architecture, whereby the generalized autonomous intelligent agent may leverage one or more special-purpose modules to evaluate any responses generated by one or more domain-specific AI models from a given cluster or committee to generate a comprehensive response to a user prompt. For instance, if two or more domain-specific AI models produce conflicting responses to a user prompt, the generalized autonomous intelligent agent, through the one or more special-purpose modules implemented through the LIDA architecture, may dynamically weigh each response according to the intent expressed by the user in their user prompt and the particular knowledge domains of the domain-specific AI models submitting proposed responses.

In an embodiment, the generalized autonomous intelligent agent is further trained to provide an emotion-based response based on historical user characteristics and sentiment analysis associated with the submitted user prompt. For instance, through evaluation of the expressed keywords, phrases, or other terms in the user prompt, the generalized autonomous intelligent agent may determine the user’s current sentiment or emotional state. In an embodiment, the generalized autonomous intelligent agent leverages a historical user datastore to construct a personal history of the user that may be used to tailor responses to user prompts from the user that comport with the user’s emotional state at any given time or otherwise with the user’s idiosyncrasies. The generalized autonomous intelligent agent may implement a personal identity network (PIN) algorithm that is trained to construct a coherent narrative from filtered experiences associated with the user over time. These filtered experiences may be maintained within a historical user datastore based on historical communications sessions between the user and the generalized autonomous intelligent agent over time. The PIN algorithm may perform narrative segmentation of these exchanged communications by dividing these communications into different segments according to detected themes, events, goals, and the like. Further, the PIN algorithm may organize these different segments into a chronological structure while highlighting key developments and achievements. The PIN algorithm may assign weights to each of these segments based on emotional significance such that user prompts identified as having greater emotional significance to the user may be given greater emphasis and addressed. Further, through the PIN algorithm, the generalized autonomous intelligent agent may generate a user profile that may be used to define an emotion-based response strategy (i.e., tailored personality) for responding to user prompts. In some instances, the generalized autonomous intelligent agent may periodically analyze the user profile and corresponding narrative segmentation and structuring to identify any patterns, biases, or areas for improvement in agent performance. Through this analysis, the generalized autonomous intelligent agent may update the user profile associated with the user and improve its tailoring of responses to user prompts according to any updated user characteristics.

In an embodiment, the generalized autonomous intelligent agent is trained to process other inputs to determine the user’s current sentiment or emotional state. For example, the generalized autonomous intelligent agent may allow the user to use one or more peripheral devices (e.g., camera, scanner, etc.) implemented on their computing device to engage with the generalized autonomous intelligent agent using real-time audiovisual communications. In an embodiment, the generalized autonomous intelligent agent uses computer vision or other machine learning algorithm/artificial intelligence techniques to dynamically, and in real-time, process the real-time audiovisual communications associated with the user to determine the user’s current sentiment or emotional state. For instance, using computer vision or other machine learning algorithm/artificial intelligence techniques, the generalized autonomous intelligent agent may generate a data representation (e.g., vectors, tensors, etc.) with values representing the user. This data representation of the user may correspond to any detected user mannerisms, eye movements, pupil dilation, body language, and the like.

In an embodiment, the generalized autonomous intelligent agent, using computer vision or other machine learning algorithm/artificial intelligence techniques, generates a baseline data representation of the user. This baseline data representation of the user may denote a neutral emotional state or sentiment that represents the user’s natural communication cadence and other idiosyncrasies. Further, this baseline data representation of the user may be reinforced using NLP techniques, which may be used to identify any expressed keywords, phrases, or other terms that may be indicative of the user’s expressed intent and current sentiment or emotional state. As the generalized autonomous intelligent agent, using computer vision or other machine learning algorithm/artificial intelligence techniques, processes a data feed comprising audiovisual communications exchanged in real-time, the generalized autonomous intelligent agent may obtain new data representations of the user, with values representing the new biometric information associated with the user. The generalized autonomous intelligent agent may compare these new data representations of the user to the baseline data representation of the user to detect any differences that may denote changes in the user’s emotional state or sentiment. For instance, certain deviations from the baseline data representation may correspond to particular emotional states or sentiments, which may be corroborated or reinforced through evaluation of additional inputs (e.g., text-based inputs, etc.). These changes to the user’s emotional state may be used by the generalized autonomous intelligent agent to tailor responses to user prompts.

At step 618, the generalized autonomous intelligent agent may return the tailored response to the user, thereby addressing the provided user prompt. For instance, through the aforementioned agent interface, the generalized autonomous intelligent agent may present the tailored response to the user through the ongoing communications session. If the user prompt was submitted through an IoT device, the generalized autonomous intelligent agent may format the tailored response according to the media used by the IoT device. For example, if the user prompt was submitted through a smart speaker device, the generalized autonomous intelligent agent may transmit the tailored response through an audial output (such as through a voice generator). This audial output may be tailored according to the known user preferences and profile.

At step 620, the generalized autonomous intelligent agent may perform automatic retraining according to any feedback provided with regard to the tailored response. As noted above, the generalized autonomous intelligent agent may continuously execute CRL using FMAL to further reinforce and/or update the generalized autonomous intelligent agent and domain-specific AI models. For instance, when the user provides feedback with regard to the provided tailored response, the generalized autonomous intelligent agent may determine whether the tailored response successfully addressed the user prompt. For instance, if the user indicates that the tailored response is unsatisfactory, the generalized autonomous intelligent agent may evaluate this feedback to determine the areas of improvement that should be addressed to improve response accuracy. For example, if the generalized autonomous intelligent agent determines that a particular domain-based AI model has provided an erroneous response according to its knowledge domain, the generalized autonomous intelligent agent may determine the source of this error and apply the aforementioned curriculum learning method to retrain the domain-specific AI model according to its assigned knowledge domain. This process may include identifying additional external data sources from which to obtain additional training materials and enhancing the training dataset used to train the domain-specific AI model by incorporating these additional training materials.

In addition to using CRL using FMAL to further reinforce and/or update the generalized autonomous intelligent agent and domain-specific AI models, the generalized autonomous intelligent agent may use SAIL or other feedback loop mechanisms to automatically evaluate its performance, identify areas for improvement, and autonomously apply updates to improve its performance. For instance, using SAIL, the generalized autonomous intelligent agent may evaluate user feedback to the tailored response and accordingly annotate the tailored response in order to refine its capabilities in processing user prompts and evaluating responses prior to dissemination to users over time. For instance, as feedback is obtained from the user with regard to the tailored response, the generalized autonomous intelligent agent may identify a need for new domain-specific AI models associated with new knowledge domains, as these new domain-specific AI models may be required to address changing contexts. Accordingly, using SAIL, the generalized autonomous intelligent agent may access the external data sources to obtain additional reference materials (such as those described above) according to the identified knowledge domains to implement and dynamically train these new domain-specific AI models. Thus, as the generalized autonomous intelligent agent and the domain-specific AI models process different user prompts associated with different users, the generalized autonomous intelligent agent may dynamically retrain and/or reinforce itself and the domain-specific AI models through the aforementioned methodologies.

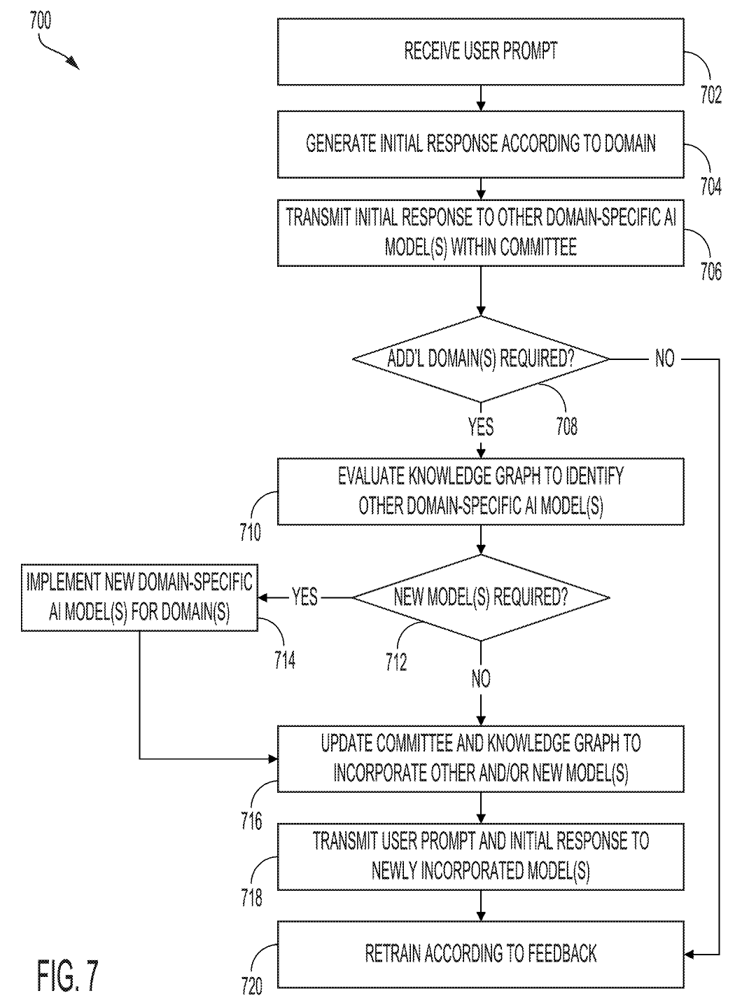

FIG. 7 shows an illustrative example of a process 700 for generating initial responses to a user prompt and transmitting the initial responses to other domain-specific AI models associated within a domain-specific AI model committee to collaboratively generate a committee response to the user prompt in accordance with at least one embodiment. The process 700 may be performed by a domain-specific AI model associated with a particular domain-specific AI model committee comprising different domain-specific AI models that may be configured to collaboratively process user prompts to generate comprehensive responses to these user prompts.

At step 702, the domain-specific AI model may receive a user prompt. As noted above, when the generalized autonomous intelligent agent has identified the appropriate domain-specific AI model committee for a user prompt, the generalized autonomous intelligent agent may transmit the user prompt to each of the domain-specific AI models associated with the domain-specific AI model committee. Further, the domain-specific AI models associated with the domain-specific AI model committee may perform individual processing of the user prompt in parallel to simultaneously process the user prompt and generate corresponding responses according to their respective knowledge domains. Thus, at step 704 and in response to the user prompt, the domain-specific AI model may generate an initial response according to its knowledge domain.

At step 706, the domain-specific AI model transmits the initial response generated according to its knowledge domain to other domain-specific AI models associated with the domain-specific AI model committee. For instance, the domain-specific AI model may circulate its response to the other domain-specific AI models associated with the domain-specific AI model committee according to the world knowledge graph to further refine this response and/or leverage collaboratively generate a finalized response to the user prompt.

At step 708, the domain-specific AI model may determine whether additional knowledge domains are required in order to generate a comprehensive and accurate response to the user prompt. Returning to an earlier illustrative example, the domain-specific AI model, during the processing of the user prompt according to its knowledge domain, may determine that a new knowledge domain is required to provide additional functionalities to support the generation of responses to the user prompt. For instance, the domain-specific AI model may determine that it requires assistance in performing mathematical operations and calculations that are required in order to generate an accurate response according to its knowledge domain. As another illustrative example, the domain-specific AI model may determine that it requires assistance in performing various language arts functions in order to generate a response that comports with the user’s linguistic idiosyncrasies or other characteristics. As yet another illustrative example, the domain-specific AI model may determine that it requires additional evaluation of programmatic code to ensure that a response that includes the programmatic code can be used without any syntax errors or other issues that may prevent successful execution of the programmatic code.

If the domain-specific AI model determines that additional knowledge domains are required in order to process the user prompt, the domain-specific AI model, at step 710, may evaluate the world knowledge graph implemented by the generalized autonomous intelligent agent to identify other domain-specific AI models that may be associated with these additional knowledge domains. Based on this evaluation, the domain-specific AI model may determine whether new domain-specific AI models are required for one or more of these additional knowledge domains.

If the domain-specific AI model determines that one or more new domain-specific AI models are required for one or more of the additional knowledge domains, the domain-specific AI model, at step 714, may implement these one or more new domain-specific AI models. As noted above, the generalized autonomous intelligent agent may implement SAIL or other feedback loop mechanisms that allow it to automatically evaluate its performance. The domain-specific AI model may transmit a request to the generalized autonomous intelligent agent to implement a new domain-specific AI model for an identified knowledge domain. Through SAIL or the other feedback loop mechanisms implemented by the generalized autonomous intelligent agent, the generalized autonomous intelligent agent may access one or more external data sources to obtain additional reference materials according to the identified knowledge domain to implement and dynamically train a new domain-specific AI model for the domain-specific AI model committee. The new domain-specific AI model may be dynamically trained through knowledge distillation, KAN, and/or MLP according to the configuration of the domain-specific AI model committee and/or the domain assigned to the new domain-specific AI model.

At step 716, the domain-specific AI model may update the domain-specific AI model committee and the world knowledge graph to incorporate the one or more new and/or identified domain-specific AI models into the domain-specific AI model committee. For instance, when a domain-specific AI model adds a new domain-specific AI model to the domain-specific AI model committee, the domain-specific AI model dynamically updates the world knowledge graph to associate the new domain-specific AI model with the domain-specific AI model committee. For The domain-specific AI model may dynamically assign the specific keywords or disciplines associated with the domain-specific AI model committee, or an identifier associated with the domain-specific AI model committee, to the new domain-specific AI model.

At step 718, the domain-specific AI model may transmit the user prompt and its initial response to the one or more newly incorporated domain-specific AI models. This may allow the one or more newly incorporated domain-specific AI models to generate new responses to the user prompt according to their knowledge domains and to evaluate and/or refine other responses from the other domain-specific AI models according to their knowledge domains to identify any inaccuracies or fine-tuning requirements that may be addressed and used to refine these responses. As noted above, any updates made to the responses generated by the domain-specific AI model may be used, at step 720, to refine (e.g., retrain or reinforce) the domain-specific AI models according to its specific knowledge domain.

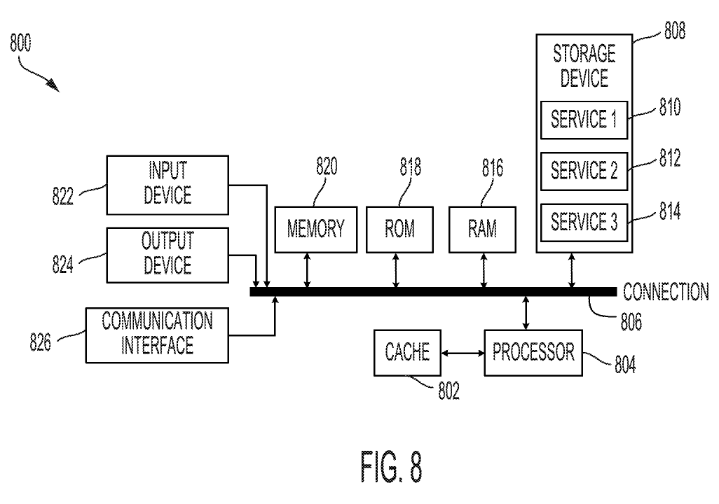

FIG. 8 illustrates a computing system architecture 800 including various components in electrical communication with each other using a connection 806, such as a bus, in accordance with some implementations. Example system architecture 800 includes a processing unit (CPU or processor) 804 and a system connection 806 that couples various system components including the system memory 820, such as ROM 818 and RAM 816, to the processor 804. The system architecture 800 can include a cache 802 of high-speed memory connected directly with, in close proximity to, or integrated as part of the processor 804. The system architecture 800 can copy data from the memory 820 and/or the storage device 808 to the cache 802 for quick access by the processor 804. In this way, the cache can provide a performance boost that avoids processor 804 delays while waiting for data. These and other modules can control or be configured to control the processor 804 to perform various actions.

Other system memory 820 may be available for use as well. The memory 820 can include multiple different types of memory with different performance characteristics. The processor 804 can include any general purpose processor and a hardware or software service, such as service 1810, service 2812, and service 3814 stored in storage device 808, configured to control the processor 804 as well as a special-purpose processor where software instructions are incorporated into the actual processor design. The processor 804 may be a completely self-contained computing system, containing multiple cores or processors, a bus, memory controller, cache, etc. A multi-core processor may be symmetric or asymmetric.

To enable user interaction with the computing system architecture 800, an input device 822 can represent any number of input mechanisms, such as a microphone for speech, a touch-sensitive screen for gesture or graphical input, keyboard, mouse, motion input, speech and so forth. An output device 824 can also be one or more of a number of output mechanisms known to those of skill in the art. In some instances, multimodal systems can enable a user to provide multiple types of input to communicate with the computing system architecture 800. The communications interface 826 can generally govern and manage the user input and system output. There is no restriction on operating on any particular hardware arrangement and therefore the basic features here may easily be substituted for improved hardware or firmware arrangements as they are developed.

Storage device 808 is a non-volatile memory and can be a hard disk or other types of computer readable media which can store data that are accessible by a computer, such as magnetic cassettes, flash memory cards, solid state memory devices, digital versatile disks, cartridges, RAMs 816, ROM 818, and hybrids thereof.

The storage device 808 can include services 810, 812, 814 for controlling the processor 804. Other hardware or software modules are contemplated. The storage device 808 can be connected to the system connection 806. In one aspect, a hardware module that performs a particular function can include the software component stored in a computer-readable medium in connection with the necessary hardware components, such as the processor 804, connection 806, output device 824, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
processing a set of historical intents to identify intent frequencies, wherein the set of historical intents corresponds to historical user prompts received during historical communications sessions between different users and a generalized autonomous intelligent agent;
identifying a set of available domain-specific artificial intelligence (AI) models corresponding to different knowledge domains, wherein the set of available domain-specific AI models is identified according to the intent frequencies;
dynamically defining a set of domain-specific AI model clusters based on the set of available domain-specific AI models and the intent frequencies, wherein the set of domain-specific AI model clusters is defined according to one or more intents from the set of historical intents, and wherein the one or more intents are selected according to the intent frequencies; and
generating a knowledge graph according to the set of domain-specific AI model clusters, wherein the knowledge graph associates different domain-specific AI models from the set of available domain-specific AI models with the set of domain-specific AI model clusters according to the one or more intents.

2. The computer-implemented method of claim 1, further comprising:
detecting a new user prompt, wherein the new user prompt is associated with an intent;
evaluating the knowledge graph according to the intent to identify a domain-specific AI model cluster from the set of domain-specific AI model clusters; and
transmitting the new user prompt to a set of domain-specific AI models associated with the identified domain-specific AI model cluster to obtain a set of responses to the new user prompt.

3. The computer-implemented method of claim 1, further comprising:
identifying a set of new domains associated with the one or more intents;
dynamically training a new set of domain-specific AI models corresponding to the set of new domains; and
assigning the new set of domain-specific AI models to the set of domain-specific AI model clusters according to the one or more intents.

4. The computer-implemented method of claim 1, wherein the set of available domain-specific AI models is generated by the generalized autonomous intelligent agent using one or more automated machine learning (AutoML) systems according to the different knowledge domains.

5. The computer-implemented method of claim 1, further comprising:
obtaining feedback corresponding to responses generated by the set of domain-specific AI model clusters to new user prompts; and
dynamically updating the different domain-specific AI models and the set of domain-specific AI model clusters according to the feedback.

6. The computer-implemented method of claim 1, wherein a set of domain-specific AI models associated with a domain-specific AI model cluster dynamically processes a user prompt corresponding to an assigned intent and intermediate responses generated by the set of domain-specific AI models to generate a collaborative cluster response to the user prompt.

7. The computer-implemented method of claim 1, wherein a set of domain-specific AI model associated with a domain-specific AI model cluster automatically add new domain-specific AI models to the domain-specific AI model cluster based on evaluation of user prompts corresponding to an assigned intent and intermediate responses generated by the set of domain-specific AI models.

8. A system, comprising:
one or more processors; and
memory storing thereon instructions that, as a result of being executed by the one or more processors, cause the system to:
process a set of historical intents to identify intent frequencies, wherein the set of historical intents corresponds to historical user prompts received during historical communications sessions between different users and a generalized autonomous intelligent agent;
identify a set of available domain-specific artificial intelligence (AI) models corresponding to different knowledge domains, wherein the set of available domain-specific AI models is identified according to the intent frequencies;
dynamically define a set of domain-specific AI model clusters based on the set of available domain-specific AI models and the intent frequencies, wherein the set of domain-specific AI model clusters is defined according to one or more intents from the set of historical intents, and wherein the one or more intents are selected according to the intent frequencies; and
generate a knowledge graph according to the set of domain-specific AI model clusters, wherein the knowledge graph associates different domain-specific AI models from the set of available domain-specific AI models with the set of domain-specific AI model clusters according to the one or more intents.

9. The system of claim 8, wherein the instructions further cause the system to:
detect a new user prompt, wherein the new user prompt is associated with an intent;
evaluate the knowledge graph according to the intent to identify a domain-specific AI model cluster from the set of domain-specific AI model clusters; and
transmit the new user prompt to a set of domain-specific AI models associated with the identified domain-specific AI model cluster to obtain a set of responses to the new user prompt.

10. The system of claim 8, wherein the instructions further cause the system to:
identify a set of new domains associated with the one or more intents;
dynamically train a new set of domain-specific AI models corresponding to the set of new domains; and
assign the new set of domain-specific AI models to the set of domain-specific AI model clusters according to the one or more intents.

11. The system of claim 8, wherein the set of available domain-specific AI models is generated by the generalized autonomous intelligent agent using one or more automated machine learning (AutoML) systems according to the different knowledge domains.

12. The system of claim 8, wherein the instructions further cause the system to:
obtain feedback corresponding to responses generated by the set of domain-specific AI model clusters to new user prompts; and
dynamically update the different domain-specific AI models and the set of domain-specific AI model clusters according to the feedback.

13. The system of claim 8, wherein a set of domain-specific AI models associated with a domain-specific AI model cluster dynamically processes a user prompt corresponding to an assigned intent and intermediate responses generated by the set of domain-specific AI models to generate a collaborative cluster response to the user prompt.

14. The system of claim 8, wherein a set of domain-specific AI model associated with a domain-specific AI model cluster automatically add new domain-specific AI models to the domain-specific AI model cluster based on evaluation of user prompts corresponding to an assigned intent and intermediate responses generated by the set of domain-specific AI models.

15. A non-transitory computer-readable storage medium storing thereon executable instructions that, as a result of being implemented by one or more processors of a computer system, cause the computer system to:
process a set of historical intents to identify intent frequencies, wherein the set of historical intents corresponds to historical user prompts received during historical communications sessions between different users and a generalized autonomous intelligent agent;
identify a set of available domain-specific artificial intelligence (AI) models corresponding to different knowledge domains, wherein the set of available domain-specific AI models is identified according to the intent frequencies;
dynamically define a set of domain-specific AI model clusters based on the set of available domain-specific AI models and the intent frequencies, wherein the set of domain-specific AI model clusters is defined according to one or more intents from the set of historical intents, and wherein the one or more intents are selected according to the intent frequencies; and
generate a knowledge graph according to the set of domain-specific AI model clusters, wherein the knowledge graph associates different domain-specific AI models from the set of available domain-specific AI models with the set of domain-specific AI model clusters according to the one or more intents.

16. The non-transitory computer-readable storage medium of claim 15, wherein the executable instructions further cause the computer system to:
detect a new user prompt, wherein the new user prompt is associated with an intent;
evaluate the knowledge graph according to the intent to identify a domain-specific AI model cluster from the set of domain-specific AI model clusters; and
transmit the new user prompt to a set of domain-specific AI models associated with the identified domain-specific AI model cluster to obtain a set of responses to the new user prompt.

17. The non-transitory computer-readable storage medium of claim 15, wherein the executable instructions further cause the computer system to:
identify a set of new domains associated with the one or more intents;
dynamically train a new set of domain-specific AI models corresponding to the set of new domains; and
assign the new set of domain-specific AI models to the set of domain-specific AI model clusters according to the one or more intents.

18. The non-transitory computer-readable storage medium of claim 15, wherein the set of available domain-specific AI models is generated by the generalized autonomous intelligent agent using one or more automated machine learning (AutoML) systems according to the different knowledge domains.

19. The non-transitory computer-readable storage medium of claim 15, wherein the executable instructions further cause the computer system to:
obtain feedback corresponding to responses generated by the set of domain-specific AI model clusters to new user prompts; and
dynamically update the different domain-specific AI models and the set of domain-specific AI model clusters according to the feedback.

20. The non-transitory computer-readable storage medium of claim 15, wherein a set of domain-specific AI models associated with a domain-specific AI model cluster dynamically processes a user prompt corresponding to an assigned intent and intermediate responses generated by the set of domain-specific AI models to generate a collaborative cluster response to the user prompt.

21. The non-transitory computer-readable storage medium of claim 15, wherein a set of domain-specific AI model associated with a domain-specific AI model cluster automatically add new domain-specific AI models to the domain-specific AI model cluster based on evaluation of user prompts corresponding to an assigned intent and intermediate responses generated by the set of domain-specific AI models.
